(19) United States
(12) Patent Application Publication
(10) Pub. No.: US 2013/0286198 A1
(43) Pub. Date: Oct. 31, 2013

(54) METHOD AND SYSTEM FOR AUTOMATICALLY DETECTING ANOMALIES AT A TRAFFIC INTERSECTION

(71) Applicants: Zhigang Fan, Webster, NY (US); Raja Bala, Webster, NY (US); Xuan Mo, State College, PA (US)

(72) Inventors: Zhigang Fan, Webster, NY (US); Raja Bala, Webster, NY (US); Xuan Mo, State College, PA (US)

(73) Assignee: XEROX CORPORATION, Norwalk, CT (US)

(21) Appl. No.: 13/455,687

(22) Filed: Apr. 25, 2012

(51) Int. Cl. H04N 7/18

(52) U.S. Cl. 348/143; 348/E07.085

(57) ABSTRACT

A method, system and processor-readable medium for automatically detecting anomalies at a traffic intersection. A set of clusters of nominal vehicle paths and a set of clusters of nominal trajectories within the nominal vehicle paths can be derived in an offline process. A set of features within each nominal trajectory among the set of clusters of nominal trajectories can be selected. A probability distribution for features indicative of nominal vehicle behavior within the nominal trajectories can be derived. An input video sequence can be received and presence of the anomaly in the vehicle path, trajectories and features within the input video sequence can be detected utilizing the derived path clusters, trajectory clusters, and feature distributions.

### TECHNICAL FIELD

Embodiments are generally related to the management of traffic systems. Embodiments are also related to video-based surveillance. Embodiments are additionally related to the detection of anomalies at traffic intersections for use in managing traffic.

### BACKGROUND

With the increased demand for security and safety, video-based surveillance systems are being utilized in a variety of rural and urban locations. A vast amount of video footage, for example, can be collected and analyzed for traffic violations, accidents, crime, terrorism, vandalism, and other suspicious activities. Because manual analysis of such large volumes of data is prohibitively costly, a pressing need exists for developing effective software tools that can aid in the automatic or semi-automatic interpretation and analysis of video data for surveillance, law enforcement and traffic control and management.

Video-based anomaly detection refers to the problem of identifying patterns in data that do not conform to expected behavior, and which may warrant special attention or action. The detection of anomalies in a transportation domain can include, for example, traffic violations, unsafe driver/pedestrian behavior, accidents, etc. FIGS. 1-2 illustrate pictorial views of exemplary transportation related anomalies captured, from, for example, video monitoring cameras. In the scenario depicted in FIG. 1, unattended baggage 100 is shown and identified by a circle. In the scenario shown in FIG. 2, a vehicle is shown approaching a pedestrian 130. Both the vehicle and pedestrian 130 are shown surrounded by a circle.

The pattern can correspond to an entire video stream and/or can be spatially or temporally localized. Several approaches have been proposed to detect traffic-related anomalies. One class of techniques is based on object tracking. In one prior art approach, nominal vehicle paths are derived and deviations thereof are searched in a live traffic video data. The vehicle paths are classified into commonly encountered (or nominal) classes during a training phase. A variety of clustering techniques can be employed to form the classes, for example, a support vector machine (SVM) classifier, Hausdorff distance-based classifier, spectral clustering or hierarchical clustering. A vehicle can be tracked and the vehicle path can be compared against the nominal classes during the test or evaluation phase. A statistically significant deviation from all nominal classes indicates an anomalous path.

A problem associated with characterizing only spatial trajectory paths is that the variations and anomalies in the vehicle trajectory along a given path cannot be identified. To tackle this problem, a second stage that analyzes features within each path class can be introduced to gather a velocity statistic within each path class. However, the statistics are computed over the entire path, so that anomalies that are spatially and temporally localized cannot be identified. A second feature analysis stage can also be introduced to gather the vehicle speed statistics at each point along the path. Such vehicle speed statistics however may not be sufficient in some cases where direction of an object motion may be an important factor.

FIG. 3 illustrates a graphical view of a stop-sign intersection 150. The stop-sign intersection 150 depicted in FIG. 3 include trajectories 110 and 120 that share the same path. The trajectory 110 represents a vehicle making a left turn from a side street to a main street with a halt at a stop sign. The trajectory 120 represents a vehicle making a right turn from the main street to the side street with very little probability of halting. The trajectories 110 and 120 can be categorized into the same path class; however the motion characteristics along each trajectory are very different, and any anomaly detection based on the aggregate statistics of speed/velocity within the path class may result in unreliable results. Other similar scenarios can be conceived where careful discernment of motion along paths is necessary for anomaly detection.

Based on the foregoing, it is believed that a need exists for an improved system and method for automatically detecting anomalies at a traffic intersection, as will be described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved traffic management methods and systems.

It is another aspect of the disclosed embodiments to provide for improved video-based surveillance methods and systems.

It is a further aspect of the disclosed embodiments to provide for improved methods and systems for automatically detecting anomalies at a traffic intersection for use in traffic control, management and/or surveillance applications.

It is yet another aspect of the disclosed embodiments to provide for improved trajectory clustering and trajectory anomaly detection techniques. The aforementioned aspects and other objectives and advantages can now be achieved as described herein. Methods and systems for automatically detecting anomalies at a traffic intersection are disclosed herein. A set of clusters of nominal vehicle paths and a set of clusters of nominal trajectories within the nominal vehicle paths can be derived in an offline process. A set of features within each nominal trajectory among the set of clusters of nominal trajectories can be selected in an offline process. A probability distribution for features indicative of nominal vehicle behavior within the nominal trajectories can be derived.

An input video sequence can be received and presence of the anomaly in the vehicle path, trajectories and features within the input video sequence can be detected utilizing the derived path clusters, trajectory clusters, and feature distributions.

The vehicle path can be tracked utilizing a background subtraction technique (e.g., Gaussian Mixture Models) to identify and isolate a stationary region of the video sequence. A blob analysis can be then employed to identify a location of the moving vehicle and to eliminate an effect of noise. A number of connected foreground pixels can be calculated and if the foreground pixel exceeds a threshold the connected segment can be assumed to be a vehicle. A centroid of the blob can be calculated with respect to time to obtain the vehicle trajectory. The process can be repeated for every video clip in a database to extract all vehicle paths. The paths can be classified utilizing a length-based approach by sampling a point along each path and defining correspondences between points on two paths. The sampling is equidistant along the length of the path. A threshold can be set on an inter-cluster distance and if the distance between the paths is within the threshold the paths are in the same class, otherwise they are assigned to different classes.

The trajectory clustering can be performed by assigning a monotonically increasing sequence of indices to each of the sample points (referred to as nodes) along the path to differentiate dissimilar vehicle trajectories based on a pre-defined rule. The vehicle trajectory can be then characterized in an order so that the nodes provide information regarding the direction of vehicle motion. The different trajectories can be then classified along the same path utilizing the clustering technique. The trajectory clustering can be employed to detect more subtle anomalies such as for example, a vehicle that overshoots a stop sign then reverses and drives forward again, a vehicle that follows a nominal path but stops outside the vicinity of the stop sign for some other failure/breakdown.

Each feature can detect an anomaly based on a scenario and each trajectory cluster includes several individual trajectories. A probability distribution of a speed data gathered at the locations corresponding to an index along an individual trajectory in a cluster can be derived, for each index along the trajectory. The data can be modeled utilizing a statistical distribution (e.g., Gaussian Mixture Model (GMM)). The features of a test trajectory at that corresponding location can be compared against a nominal distribution during a test phase. The spatial location of the anomaly can be identified, thus providing useful information to a surveillance operator. A speed data for vehicles moving in the opposite direction (from main to side street) can also be included in the statistics if the speed analysis is carried out on the vehicle path rather than the trajectory. Such an approach distinguishes between two vehicles moving along the identical path but with different motion trajectory. The computational complexity for the evaluation of the test video clips is relatively low since the trajectory distance definitions are simple.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIGS. 1-2 illustrate an exemplary view of transportation related anomalies;

FIG. 3 illustrates a perspective view of a stop-sign intersection;

FIG. 4 illustrates a schematic view of a computer system, in accordance with the disclosed embodiments;

FIG. 5 illustrates a schematic view of a software system including a video-based anomalies detection module, an operating system, and a user interface, in accordance with the disclosed embodiments;

FIG. 6 illustrates a block diagram of a video-based anomalies detection system, in accordance with the disclosed embodiments;

FIG. 7 illustrates a high level flow chart of operations illustrating logical operational steps of method for automatically detecting anomalies at a traffic intersection in a training phase, in accordance with the disclosed embodiments;

FIG. 8 illustrates a perspective view of a stop-sign intersection, in accordance with the disclosed embodiments;

FIG. 9 illustrates a processed video image utilizing a background subtraction and a blob analysis to identify a vehicle, in accordance with the disclosed embodiments;

FIG. 10 illustrates a processed video image utilizing a blob centroid calculation and path derivation to track the vehicle path, in accordance with the disclosed embodiments;

FIG. 11 illustrates a schematic view of an equidistant sampling of path lengths, in accordance with the disclosed embodiments;

FIG. 12 illustrates a processed video image utilizing a path-based distance metric, in accordance with the disclosed embodiments;

FIG. 13 illustrates a perspective view of two vehicles moving on a similar path but along different trajectories, in accordance with the disclosed embodiments;

FIG. 14 illustrates a graph depicting a path node visitation order for the vehicle motions in FIG. 13, in accordance with the disclosed embodiments;

FIG. 15 illustrates a graph depicting feature (speed) analysis at a particular location along a trajectory, in accordance with the disclosed embodiments;

FIGS. 16-17 illustrate a graph depicting a speed profile with respect to entire trajectory, in accordance with the disclosed embodiments; and

FIG. 18 illustrates a high level flow chart of operations illustrating logical operational steps of method for automatically detecting anomalies at the traffic intersection in an evaluation phase, in accordance with the disclosed embodiments.

### DETAILED DESCRIPTION

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one of skill in the art, the present invention can be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.) The computer program code, however, for carrying out operations of the present invention may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

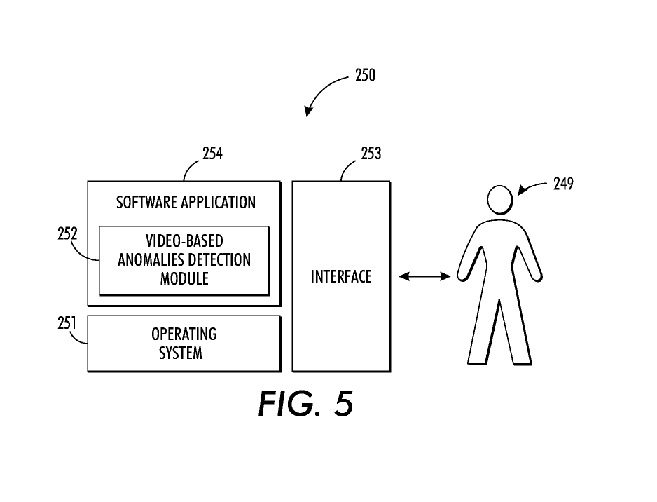

FIGS. 4-5 are provided as exemplary diagrams of data-processing environments in which embodiments of the present invention may be implemented. It should be appreciated that FIGS. 4-5 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 4, the disclosed embodiments may be implemented in the context of a data-processing system 200 that includes, for example, a central processor 201, a main memory 202, an input/output controller 203, a keyboard 204, an input device 205 (e.g., a pointing device, such as a mouse, track ball, and pen device, etc.), a display device 206, a mass storage 207 (e.g., a hard disk), an image capturing unit 208 and a USB (Universal Serial Bus) peripheral connection 211. As illustrated, the various components of data-processing system 200 can communicate electronically through a system bus 210 or similar architecture. The system bus 210 may be, for example, a subsystem that transfers data between, for example, computer components within data-processing system 200 or to and from other data-processing devices, components, computers, etc.

FIG. 5 illustrates a computer software system 250 for directing the operation of the data-processing system 200 depicted in FIG. 4. Software application 254, stored in main memory 202 and on mass storage 207, generally includes a kernel or operating system 251 and a shell or interface 253. One or more application programs, such as software application 254, may be “loaded” (i.e., transferred from mass storage 207 into the main memory 202) for execution by the data-processing system 200. The data-processing system 200 receives user commands and data through user interface 253; these inputs may then be acted upon by the data-processing system 200 in accordance with instructions from operating system module 252 and/or software application 254.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

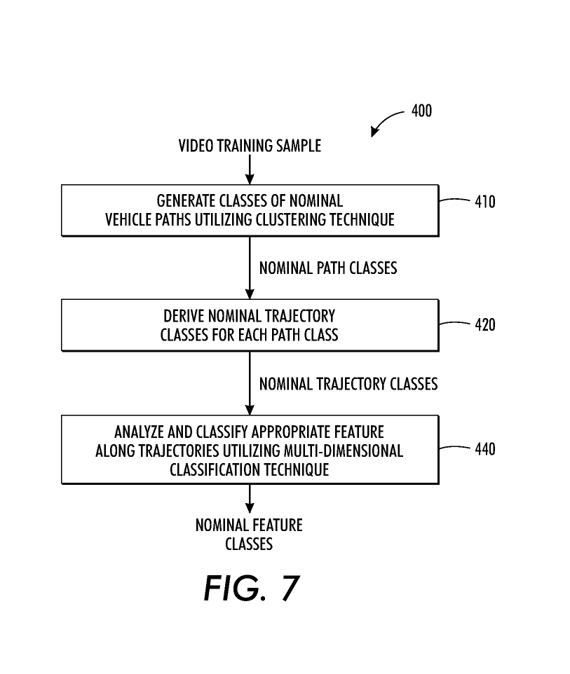

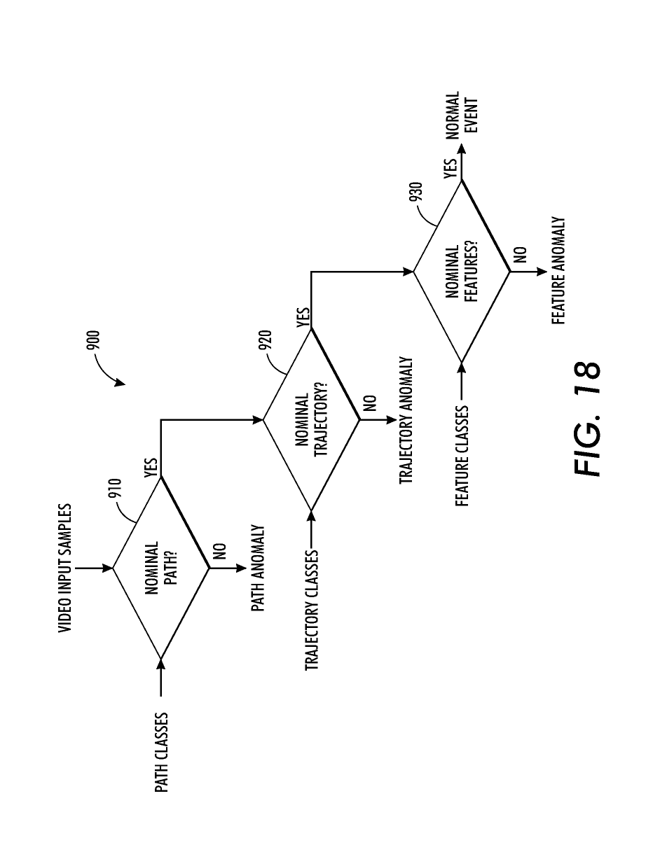

The interface 253, which is preferably a graphical user interface (GUI), also serves to display results, whereupon the user may supply additional inputs or terminate the session. In an embodiment, operating system 251 and interface 253 can be implemented in the context of a “Windows” system. It can be appreciated, of course, that other types of systems are potential. For example, rather than a traditional “Windows” system, other operation systems, such as, for example, Linux may also be employed with respect to operating system 251 and interface 253. The software application 254 can include a video-based anomalies detection module 252 for automatically detecting anomalies at a traffic intersection. Software application 254, on the other hand, can include instructions, such as the various operations described herein with respect to the various components and modules described herein, such as, for example, the methods 400 and 900 depicted in FIGS. 7 and 18.

FIGS. 4-5 are thus intended as examples, and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

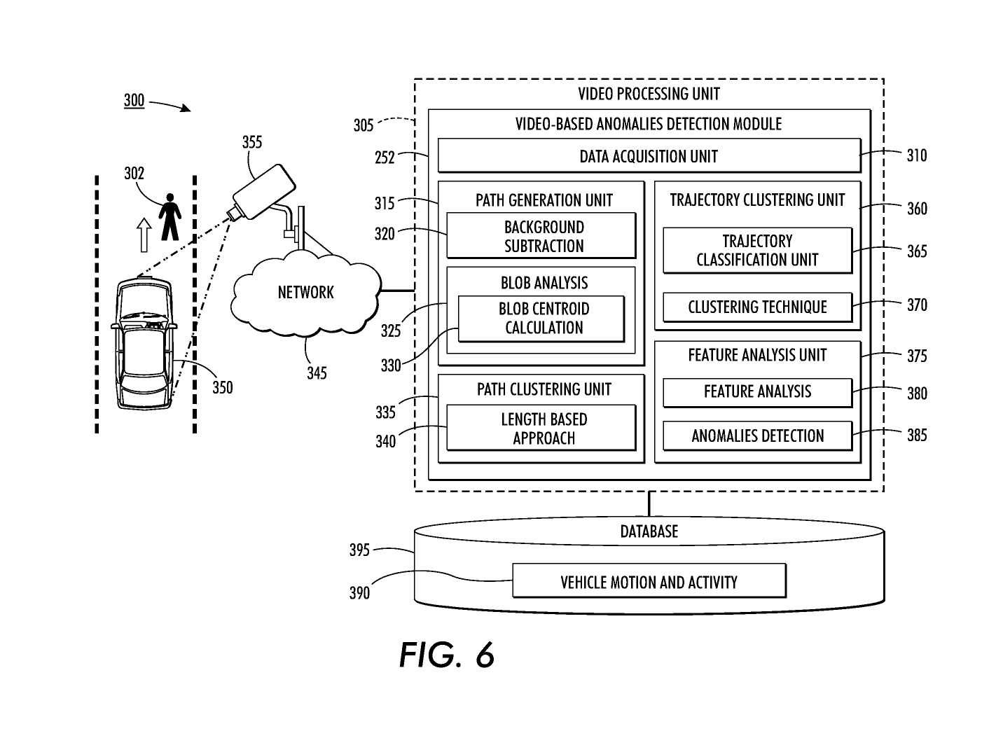

FIG. 6 illustrates a block diagram of a video-based anomalies detection system 300, in accordance with the disclosed embodiments. Note that in FIGS. 4-18 identical or similar parts or elements are generally indicated by identical reference numeral. The video-based anomalies detection system 300 detects anomalies or abnormal patterns 302 from a video footage to identify unsafe driver/pedestrian behavior, accidents, traffic violations, suspicious activity, etc. The video-based anomalies detection system 300 detects abnormal patterns 302 in general scenarios where there are multiple vehicles potentially moving along complex trajectories, and in the presence of clutter and other background noise.

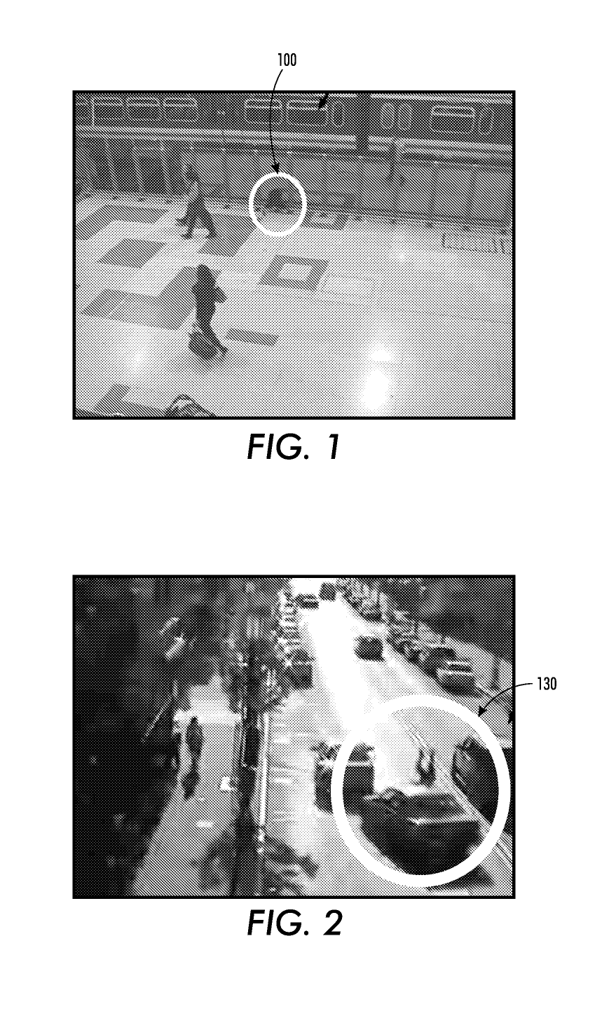

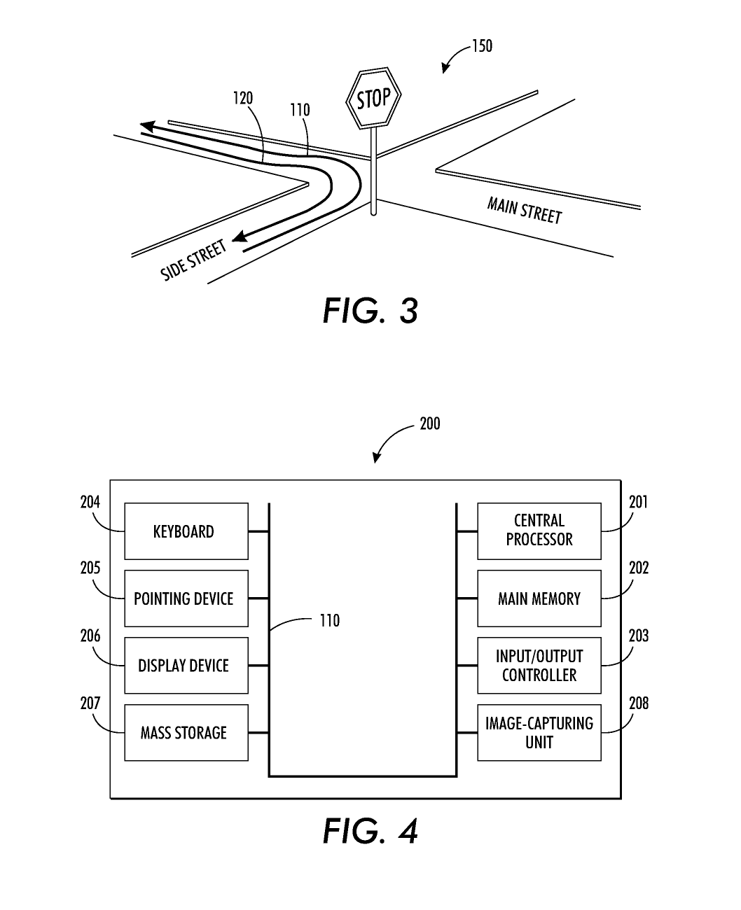

The video-based anomalies detection system 300 generally includes an image capturing unit 355 (e.g., camera) for capturing a vehicle 350 in motion within an effective field of view. The image capturing unit 355 can be operatively connected to a video processing unit 305 via a network 340. Note that the image capturing unit 355 described in greater detail herein are analogous or similar to the image capturing unit 108 of the data-processing system 100, depicted in FIG. 1. The image capturing unit 355 may include built-in integrated functions such as image processing, data formatting and data compression functions.

Note that the network 345 may employ any network topology, transmission medium, or network protocol. The network 345 may include connections, such as wire, wireless communication links, or fiber optic cables. Network 345 can also be an Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages.

The video-based anomalies detection system 300 includes a video-based anomalies detection module 252 for automatically detecting the anomalies 302 at a traffic intersection. The video-based anomalies detection module 252 further includes a data acquisition unit 310, a path generation unit 315, a path clustering unit 335, a trajectory clustering unit 360, and a feature analyzing unit 375. It can be appreciated that the data acquisition unit 310, the path generation unit 315, the path clustering unit 335, the trajectory clustering unit 360, and the feature analyzing unit 375 can be implemented as software modules.

The concepts in this invention will be disclosed via an example of anomaly detection at a stop sign traffic intersection. It is understood that the concepts can be applied to a variety of scenarios relating to the transportation domain.

In a training phase, the data acquisition unit 310 gathers a duration, of video footage at a stop sign intersection. The footage may include a combination of natural, as well as staged events so that there is sufficient representation of both nominal and anomalous activity. The segments containing vehicle motion and activity 390 can be automatically extracted to generate a database 395 of short video clips. A portion of these clips can be employed to train the anomaly detection algorithm, and the remaining data can be employed as a test set.

The path generation unit 315 and the path clustering unit 335 generate and cluster a class of nominal vehicle paths utilizing a clustering technique 370. A path is defined via a locus of spatial (x-y) coordinates. The clustering technique 370 can be for example, a background subtraction 320, a blob analysis 325, a blob centroid calculation 330 and a length-based approach 340.

The trajectory clustering unit 360 derives and clusters a trajectory class for each path class via a trajectory classification unit 365 and the clustering technique 370. A trajectory is defined to encompass both spatial and temporal dimensions, and can capture spatial location as well as direction of motion. The trajectory clustering unit 360 enables disambiguation of different vehicle trajectories along similar spatial path and to detect the subtle anomaly 302 in vehicle motion along a path. The feature analyzing unit 375 analyzes the video and computes and classifies appropriate features along the trajectories utilizing a feature analysis 380. The feature classification is then used for feature anomaly detection 385.

Once the training phase is completed, an input video sequence for anomaly detection can be received from the image capturing unit 355 and the presence of anomalies 302 in paths, trajectories and features within the input video sequence can be detected utilizing respectively the derived path clusters, trajectory clusters, and feature distributions. Such an approach can be readily detected/enforced by designing a test video clip that involve identical vehicle paths but dissimilar vehicle trajectories.

FIG. 7 illustrates a high level flow chart of operations illustrating logical operational steps of method 400 for building path, trajectory, and feature classes in a training phase, in accordance with the disclosed embodiments. FIG. 18 describes the 3-stage detection of anomalies in input video sequences, corresponding respectively to path, trajectory, and feature related anomalies. It can be appreciated that the logical operational steps shown in FIGS. 7 and 18 can be implemented or provided via, for example, a module such as module 154 shown in FIG. 2 and can be processed via a processor, such as, for example, the processor 101 shown in FIG. 1. The method 400 illustrates three stage frameworks towards video anomaly detection for transportation applications. In the first stage, anomalous paths can be identified using the path clustering techniques. In the second stage, anomalous trajectories can be identified using trajectory clustering techniques. In one embodiment, the trajectory is defined via a sorted index function. In the third stage, anomalous vehicle behavior within the trajectory can be detected by identifying relevant features and using a multi-dimensional classification technique to derive classes with respect to these features. The three stages produce excellent anomaly detection results, and overcome certain limitations encountered with previous approaches.

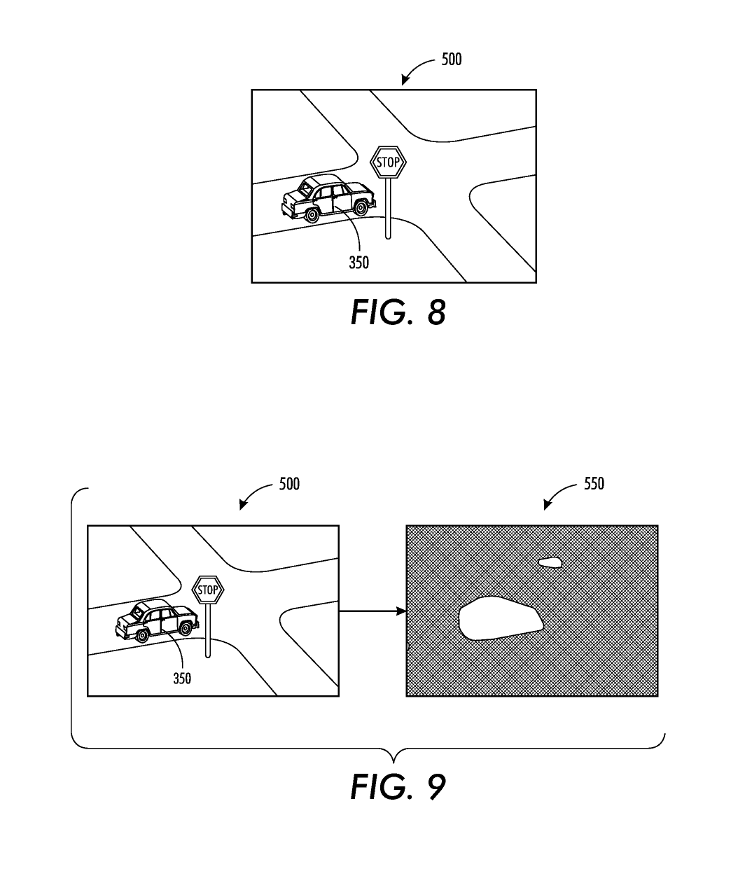

Initially, as illustrated at block 410, an offline process is used to generate and cluster a class of nominal vehicle paths utilizing a clustering technique. Path generation requires several video processing steps to identify and track the vehicle, described next. FIG. 8 illustrates a perspective view of the stop-sign intersection 500, in accordance with the disclosed embodiments. An intersection is a road junction where two or more roads either meet or cross at grade (they are at the same level). An intersection may be 3-way—a T junction or fork, 4-way—a crossroads, or 5-way or more. Stop-controlled intersections have one or more “STOP” signs.

FIG. 9 illustrates a processed video image 550 utilizing background subtraction 320 and blob analysis 325 to identify the vehicle 350, in accordance with the disclosed embodiments. Background subtraction 320 identifies and separates stationary from moving regions of a video sequence. The background subtraction 320 can be for example, be derived via a Gaussian Mixture Model (GMM). The GMM is a parametric probability density function represented as a weighted sum of Gaussian probability density functions. Intensity or color values of each pixel gathered over time are modeled via a GMM. Parameters such as the variance and persistence of each Gaussian distribution in the mixture are continually computed, and used to determine whether a pixel is a part of the foreground or background.

Blob analysis 325 can be then employed to identify the location of the moving vehicle 350 while reducing the effect of noise. Blob analysis 325 refers to visual modules that are aimed at detecting points and/or regions in the image that differ in properties like brightness or color compared to the surrounding area. The number of connected foreground pixels can be calculated and if the foreground pixels exceed a threshold, the connected segment can be assumed to be the vehicle 350. FIG. 9 illustrate an example of the detected vehicle 350 utilizing blob analysis 325.

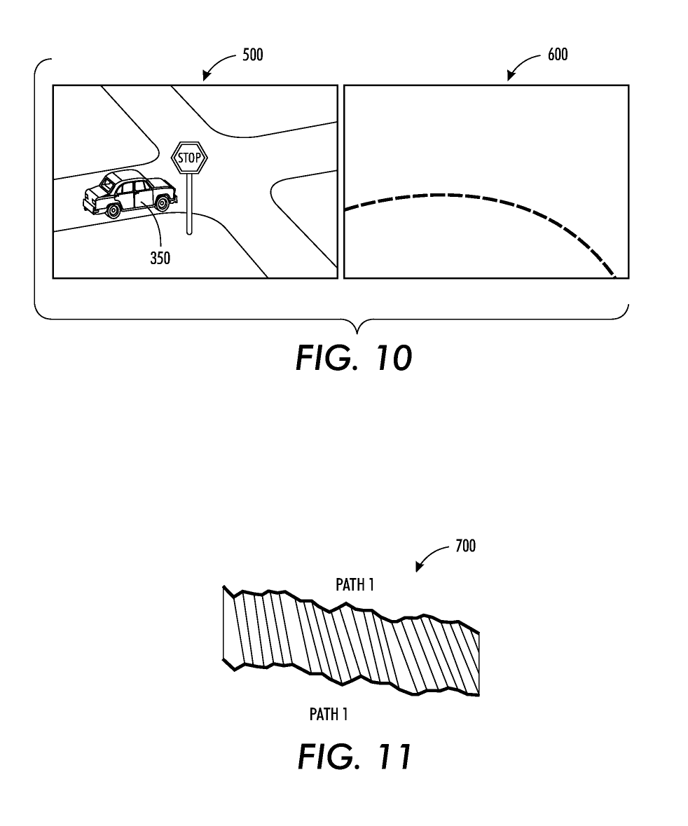

FIG. 10 illustrates a processed video image 600 utilizing the blob centroid calculation 330 and path derivation to track the vehicle path, in accordance with the disclosed embodiments. The centroid of the blob 330 can be calculated and collected with respect to time to obtain a vehicle trajectory. FIG. 10 illustrate an example of the extracted path. The process can be repeated for every video clip in the database 395 to extract all the vehicle paths.

Once the paths have been identified, they can be clustered into nominal path classes. Clustering requires a means of defining distance between paths. An exemplary definition is now elaborated. First a given path is uniformly sampled along its length to form a set of equidistant points along the path. FIG. 11 illustrates a schematic view of equidistant sampling of two path lengths 650, in accordance with the disclosed embodiments. For example, let L define the total length of a path, N refer to the number of sample points, and T(x) be a path function representing the point along the path of distance x from one endpoint. The sample points can be represented as shown below in equation (2):

$$T ( \frac{L}{N - 1} i ) \\ i = 0 , 1 , … , N - 1 \qquad ( 2 )$$

Next for a given point on a first path, we define the corresponding point on a second path to be the sample point closest to the point on the first path. Formally, let p be a point on a first path, and let c(p, T) define the corresponding point on a second path defined by path function T, defined as:

$$c ( p , T ) = T \{ \begin{matrix}\frac{L}{N - 1} \times {arg min}_{i} & E [ p , T ( \frac{L}{N - 1} i ) ]\end{matrix} \} \\ i = 0 , 1 , … , N - 1 \qquad ( 3 )$$

Equation (3) is used to establish corresponding pairs {pᵢ, C(pᵢ, T)} for all points pᵢ along the first path. Next, the distance between each corresponding pair is obtained. Finally the distance between the first and second path is defined as the mean of distances between all corresponding pairs. This is a variant of the Hausdorff distance metric. Formally, let D(S,T) define the path distance from S to T. Then the distance between path S(x) and T(x) can be written as shown in equation (4):

$$D ( S , T ) = mean ( E \{ S ( \frac{L}{N - 1} i ) , c [ S ( \frac{L}{N - 1} i ) , T ] \} ) \\ i = 0 , 1 , … , N - 1 \qquad ( 4 )$$

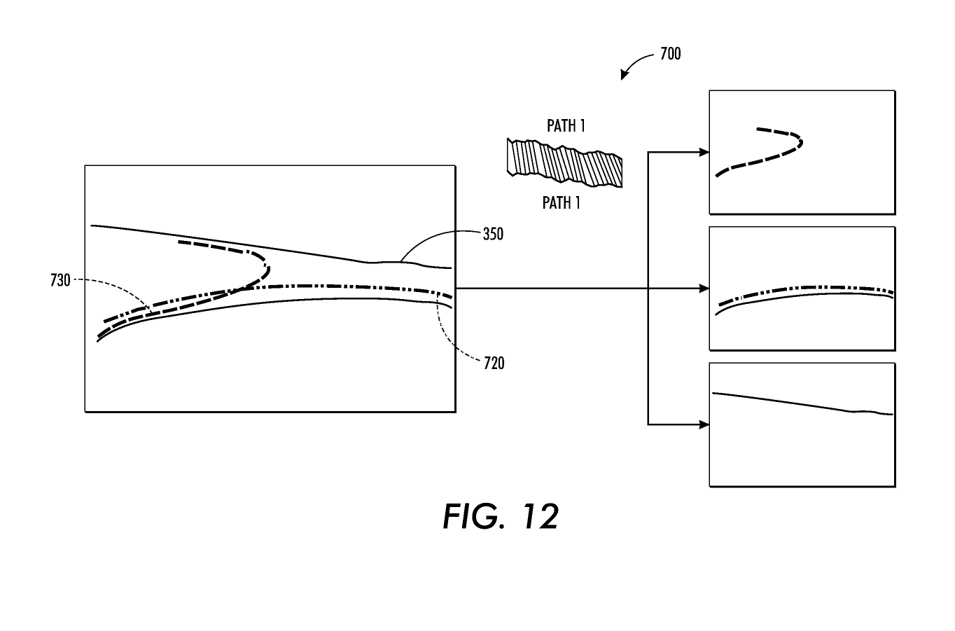

Given the aforementioned definition for path distance, clustering of the paths can now be performed. A threshold TH is set on inter-cluster distance. Namely, if the distance D(S,T) between paths T and S is within the threshold TH, then path S and path T are assigned to the same class, otherwise they are assigned to different classes. FIG. 12 illustrates a processed video image 700 utilizing a path-based distance metric, in accordance with the disclosed embodiments. The different trajectories 710, 720 and 730 can be represented by different colors and the similar paths can be classified into the same class.

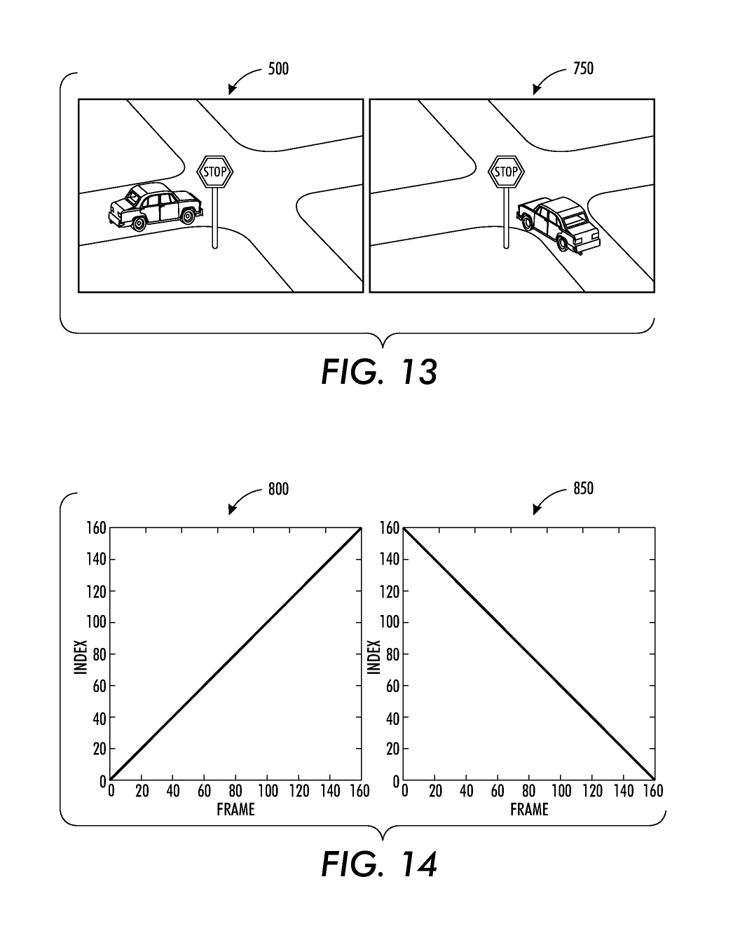

For each path class, trajectory classes are next defined as indicated at block 420. Contrary to a path that defines only spatial coordinates, a trajectory is defined to also include the temporal dimension, and convey direction of motion. In the preferred embodiment, a monotonically increasing sequence of indices is assigned to the sample points along the path. The assignment is according to a predefined rule—for example starting at the leftmost (or uppermost) endpoint and finishing at the rightmost (or lowermost) endpoint. This forms a sorted index function. The trajectory is then defined as the order in which the sample points are visited as a function of time. Such a definition enables disambiguation of different vehicle trajectories along the same path. FIG. 13 illustrates a perspective view of two vehicles 500 and 750 moving on the same path but along different trajectories, in accordance with the disclosed embodiments. FIG. 14 shows path visitation order corresponding to these two vehicles. It is clearly seen that the trajectory provides important information regarding the direction of the vehicle motion along the given path. Trajectories can be clustered and classified using the same or similar methods as used to cluster paths.

Note that the vehicles 500 and 750 moving in opposite directions is described to illustrate how dissimilar trajectories can share the same spatial path; however, they should not be interpreted in any limiting way. It will be apparent to those of skill in the art the described approach can be utilized to detect more subtle anomalies for example, a vehicle that overshoots the stop sign then reverses and drives forward again or the vehicle that follows the nominal path but stops outside of the vicinity of the stop sign for some other failure/breakdown.

To analyze and detect further anomalies in vehicle motion within trajectories, one or more appropriate features along the trajectories can be derived and classified utilizing known classification techniques, as depicted at block 440. Different features can be employed based on the particular scenario and application. Table 1 shows different types of features and the corresponding anomalies 302 that can be detected with these features.

| Feature | Anomaly |
|---|---|
| Velocity amplitude | 1. Speeding |
| | 2. Stop sign violation |
| | 3. Red light violation |
| Velocity direction | 1. Illegal lane change |
| | 2. Dramatic swerving |
| | 3. Driving in wrong direction |
| | 4. Illegal U-turn |
| Object Size | 1. Human on the road |

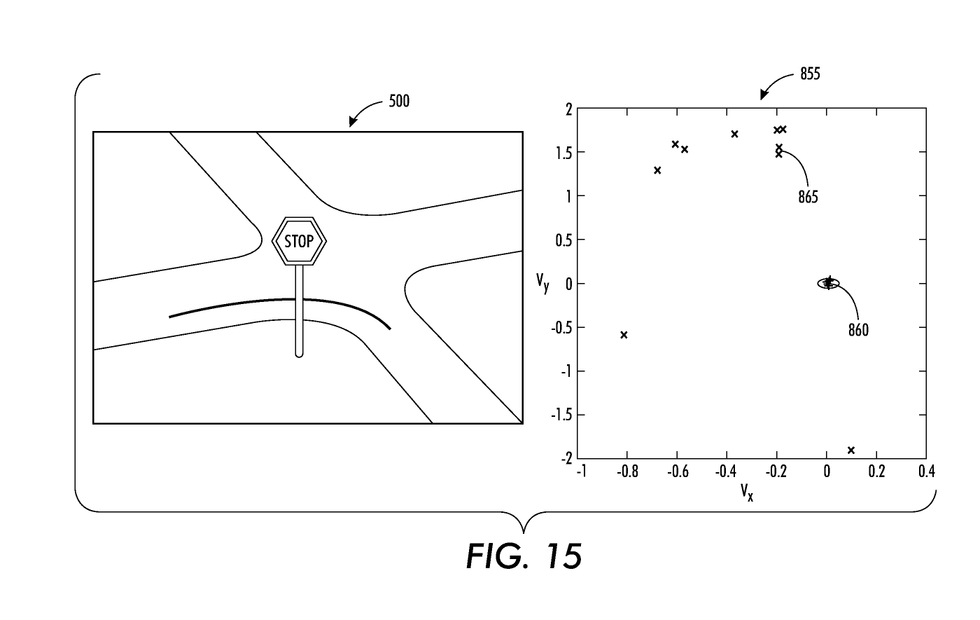

In the exemplary embodiment, anomalies at a stop-sign intersection can be effectively described utilizing speed in x- and y-directions as the features, as shown in graph 855 in FIG. 15. Note that in the previous training step, each trajectory cluster includes several individual trajectories. A probability distribution of speed data can be derived, for each index along the trajectory. The distribution can be, for example, a Gaussian Mixture Model (GMM)). The center of the circle 860 in the plot 855 represent the mean of all the nominal speed data gathered a particular spatial location along the given trajectory near the stop sign. The radius of the circle 855 represents the covariance of the features. Since in all nominal cases, vehicles come to a complete or rolling stop near the stop sign, the nominal speed is close to zero at this location.

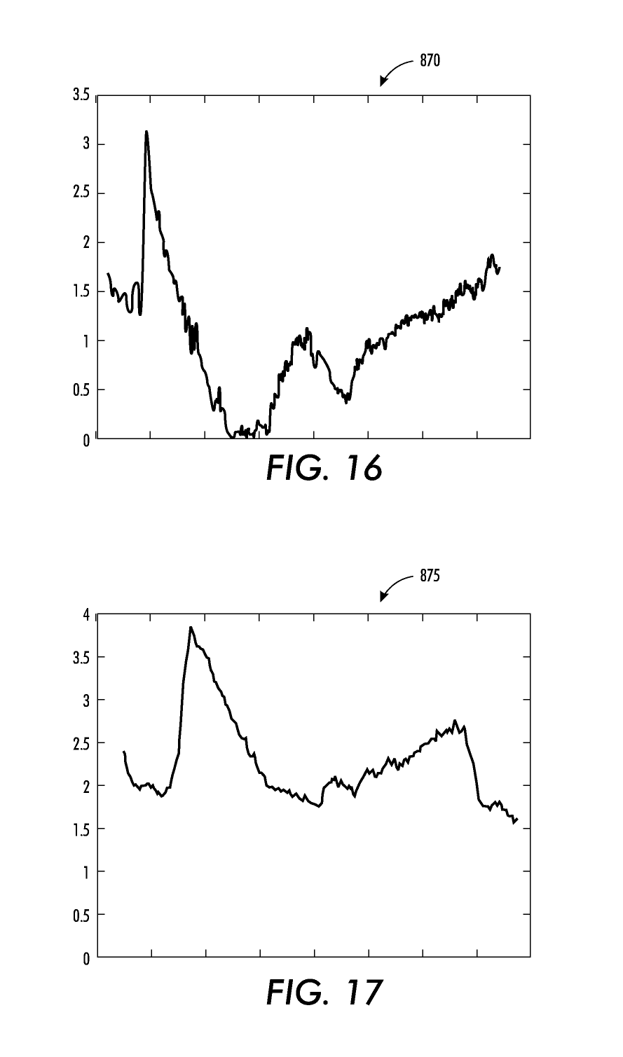

During a test phase, the features of a test trajectory at that corresponding location can be compared against a nominal distribution, as illustrated in FIG. 15. The points 865 correspond to features computed for vehicles 350 that do not stop at the intersection. These points lie outside the nominal speed cluster at that location (corresponding to vehicles 350 that do not stop at the intersection), and are thus considered anomalous 302. The spatial location of the anomaly 302 can also be identified, thus providing useful information to a surveillance operator. FIGS. 16-17 illustrate a graph 870 and 875 depicting a speed profile on an entire trajectory, in accordance with the disclosed embodiments. The graph 870 and 875 depicts the velocity of sample points in a nominal trajectory and an anomalous trajectory respectively.

FIG. 18 illustrates a high level flow chart of operations illustrating logical operational steps of a three-stage method 900 for automatically detecting anomalies 302 at the traffic intersection in an evaluation phase, in accordance with the disclosed embodiments. An input video sequence for anomaly detection can be received and presence of anomalies 302 in the paths, trajectories and features within the input video sequence can be detected in successive stages utilizing the derived path clusters, trajectory clusters, and feature distributions as illustrated at blocks 910, 920 and 930. One of the advantages with the three-stage approach is that computational complexity for the evaluation of new test video clips is relatively low since the computation at each stage is relatively simple.

Based on the foregoing, it can be appreciated that a number of embodiments, preferred and alternative, are disclosed herein. For example, in one embodiment, a multi-stage method for detecting anomalies in video footage of vehicle traffic, can be implemented. Such a method can include, for example, deriving in an offline process a set of clusters of nominal vehicle paths and a set of clusters of nominal trajectories within the nominal vehicle paths; selecting in an offline process a set of features within each nominal trajectory among the set of clusters of nominal trajectories and deriving a probability distribution for features indicative of nominal vehicle behavior within the nominal trajectories; and detecting in three successive stages, anomalies in an input video sequence, the anomalies corresponding respectively to a path, a trajectory, and feature distributions. In another embodiment, an operation or step can be implemented for reporting the anomalies via a user interface.

In another embodiment, the step or operation of deriving in the offline process a set of clusters of nominal vehicle paths, can further include steps or operations of utilizing a background subtraction to differentiate stationary from moving portions of the input video sequence; utilizing a blob analysis to remove noise and identify a moving vehicle; tracking a blob centroid to identify a vehicle path; defining a length-based distance metric between two paths; and clustering vehicle paths utilizing the distance metric. In still another embodiment, the aforementioned background subtraction can employ a Gaussian mixture model. In yet another embodiment, the computing the length-based distance metric between the two paths can include: generating a sampling of points along each path among the two paths; identifying a corresponding point on a second path among the two paths as being a closest of all points on the second path for each point on a first path among the two paths; and defining a distance between paths as an average of distances between all pairs of corresponding points.

In another embodiment, clustering vehicle paths utilizing the distance metric, can further include establishing a threshold on an inter-cluster distance; assigning two paths to a same cluster if a distance of the two paths is less than the threshold; and assigning the two paths to different clusters if a distance of the two paths is greater than the threshold. In yet another embodiment, deriving the set of clusters of nominal trajectories within the nominal vehicle paths, can further include assigning a monotonically increasing sequence of indices to sample points along a vehicle path; defining a trajectory as an order by which the sequence of indices is visited by a vehicle along the vehicle path; defining a distance metric between two trajectories; and clustering trajectories according to the distance metric. In other embodiments, the selected features within nominal trajectories can include at least one of a speed of motion and a direction of motion. In another embodiment, the probability distribution for the features can be based on a Gaussian mixture model.

In other embodiments, determining the three successive stages can include computing a path for a vehicle; determining if the path belongs to at least one of a precomputed path class, and if so labeling the path as a nominal path, and if not, labeling the path as an anomalous path; computing a trajectory for each nominal path; determining if the trajectory belongs to at least one of a precomputed trajectory class, and if so labeling the trajectory as a nominal trajectory, and if not labeling the trajectory as an anomalous trajectory; computing selected features along the nominal trajectory and a statistical distance between computed features and pre-computed feature distributions for each nominal trajectory; and labeling a feature as nominal feature if a distance is less than a predetermined threshold, and if not labeling, the feature as an anomalous feature. In still some embodiments, reporting the anomalies can include marking frames and spatial locations of the anomalies in the user interface.

In another embodiment, a multi-stage system for detecting anomalies in video footage of vehicle traffic can be implemented. Such a system can include, for example, a processor; a data bus coupled to the processor; and a computer-usable medium embodying computer program code, the computer-usable medium being coupled to the data bus. In some embodiments, the computer program code can include instructions executable by the processor and configured for: deriving in an offline process a set of clusters of nominal vehicle paths and a set of clusters of nominal trajectories within the nominal vehicle paths; selecting in an offline process a set of features within each nominal trajectory among the set of clusters of nominal trajectories and deriving a probability distribution for features indicative of nominal vehicle behavior within the nominal trajectories; and detecting in three successive stages, anomalies in an input video sequence, the anomalies corresponding respectively to a path, a trajectory, and feature distributions. In some embodiments, such instructions can be further configured for reporting the anomalies via a user interface.

In other embodiments, instructions for deriving in the offline process a set of clusters of nominal vehicle paths, can further include instructions configured for utilizing a background subtraction to differentiate stationary from moving portions of the input video sequence; utilizing a blob analysis to remove noise and identify a moving vehicle; tracking a blob centroid to identify a vehicle path; defining a length-based distance metric between two paths; and clustering vehicle paths utilizing the distance metric. In some embodiments, the aforementioned background subtraction can include the use of a Gaussian mixture model.

In another embodiment, instructions can be further configured for computing the length-based distance metric between the two paths by: generating a sampling of points along each path among the two paths; identifying a corresponding point on a second path among the two paths as being a closest of all points on the second path for each point on a first path among the two paths; and defining a distance between paths as an average of distances between all pairs of corresponding points. In other embodiments, the instructions for clustering vehicle paths utilizing the distance metric, can further include: establishing a threshold on an inter-cluster distance; assigning two paths to a same cluster if a distance of the two paths is less than the threshold; and assigning the two paths to different clusters if a distance of the two paths is greater than the threshold.

In other embodiments, the instructions for deriving the set of clusters of nominal trajectories within the nominal vehicle paths, can further include instructions for assigning a monotonically increasing sequence of indices to sample points along a vehicle path; defining a trajectory as an order by which the sequence of indices is visited by a vehicle along the vehicle path; defining a distance metric between two trajectories; and clustering trajectories according to the distance metric.

In yet another embodiment, such instructions can be further configured for determining the three successive stages by: computing a path for a vehicle; determining if the path belongs to at least one of a precomputed path class, and if so labeling the path as a nominal path, and if not, labeling the path as an anomalous path; computing a trajectory for each nominal path; determining if the trajectory belongs to at least one of a precomputed trajectory class, and if so labeling the trajectory as a nominal trajectory, and if not labeling the trajectory as an anomalous trajectory; computing selected features along the nominal trajectory and a statistical distance between computed features and pre-computed feature distributions for each nominal trajectory; and labeling a feature as nominal feature if a distance is less than a predetermined threshold, and if not labeling, the feature as an anomalous feature.

In still another embodiment, a processor-readable medium storing code representing instructions to cause a process to perform a multi-stage method for detecting anomalies in video footage of vehicle traffic can be implemented. Such code can include code to, for example, derive in an offline process a set of clusters of nominal vehicle paths and a set of clusters of nominal trajectories within the nominal vehicle paths; select in an offline process a set of features within each nominal trajectory among the set of clusters of nominal trajectories and deriving a probability distribution for features indicative of nominal vehicle behavior within the nominal trajectories; and detect in three successive stages, anomalies in an input video sequence, the anomalies corresponding respectively to a path, a trajectory, and feature distributions.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A multi-stage method for detecting anomalies in video footage of vehicle traffic, said method comprising:
deriving in an offline process a set of clusters of nominal vehicle paths and a set of clusters of nominal trajectories within said nominal vehicle paths;
selecting in an offline process a set of features within each nominal trajectory among said set of clusters of nominal trajectories and deriving a probability distribution for features indicative of nominal vehicle behavior within said nominal trajectories; and
detecting in three successive stages, anomalies in an input video sequence, said anomalies corresponding respectively to a path, a trajectory, and feature distributions.

2. The method of claim 1 further comprising reporting said anomalies via a user interface.

3. The method of claim 1 wherein deriving in said offline process a set of clusters of nominal vehicle paths, further comprises:
utilizing a background subtraction to differentiate stationary from moving portions of said input video sequence;
utilizing a blob analysis to remove noise and identify a moving vehicle;
tracking a blob centroid to identify a vehicle path;
defining a length-based distance metric between two paths; and
clustering vehicle paths utilizing said distance metric.

4. The method of claim 3 wherein said background subtraction employs a Gaussian mixture model.

5. The method of claim 3 further comprising computing said length-based distance metric between said two paths by:
generating a sampling of points along each path among said two paths;
identifying a corresponding point on a second path among said two paths as being a closest of all points on said second path for each point on a first path among said two paths; and
defining a distance between paths as an average of distances between all pairs of corresponding points.

6. The method of claim 3 wherein clustering vehicle paths utilizing said distance metric, further comprises:
establishing a threshold on an inter-cluster distance; and
assigning two paths to a same cluster if a distance of said two paths is less than said threshold; and
assigning said two paths to different clusters if a distance of said two paths is greater than said threshold.

7. The method of claim 1 wherein said deriving said set of clusters of nominal trajectories within said nominal vehicle paths, further comprises:
assigning a monotonically increasing sequence of indices to sample points along a vehicle path;
defining a trajectory as an order by which said sequence of indices is visited by a vehicle along the said vehicle path;
defining a distance metric between two trajectories; and
clustering trajectories according to said distance metric.

8. The method of claim 1 wherein the selected features within nominal trajectories comprise at least one of a speed of motion and a direction of motion.

9. The method of claim 1 wherein said probability distribution for said features is based on a Gaussian mixture model.

10. The method of claim 1 further comprising determining said three successive stages by:
computing a path for a vehicle;
determining if said path belongs to at least one of a precomputed path class, and if so labeling said path as a nominal path, and if not, labeling said path as an anomalous path;
computing a trajectory for each nominal path;
determining if said trajectory belongs to at least one of a precomputed trajectory class, and if so labeling said trajectory as a nominal trajectory, and if not labeling said trajectory as an anomalous trajectory;
computing selected features along said nominal trajectory and a statistical distance between computed features and pre-computed feature distributions for each nominal trajectory;
labeling a feature as nominal feature if a distance is less than a predetermined threshold, and if not labeling, said feature as an anomalous feature.

11. The method of claim 2 wherein reporting said anomalies comprises marking frames and spatial locations of said anomalies in said user interface.

12. A multi-stage system for detecting anomalies in video footage of vehicle traffic, said system comprising:
a processor;
a data bus coupled to said processor; and
a computer-usable medium embodying computer code, said computer-usable medium being coupled to said data bus, said computer program code comprising instructions executable by said processor and configured for:
deriving in an offline process a set of clusters of nominal vehicle paths and a set of clusters of nominal trajectories within said nominal vehicle paths;
selecting in an offline process a set of features within each nominal trajectory among said set of clusters of nominal trajectories and deriving a probability distribution for features indicative of nominal vehicle behavior within said nominal trajectories; and
detecting in three successive stages, anomalies in an input video sequence, said anomalies corresponding respectively to a path, a trajectory, and feature distributions.

13. The system of claim 12 wherein said instructions are further configured for reporting said anomalies via a user interface.

14. The system of claim 12 wherein said instructions for deriving in said offline process a set of clusters of nominal vehicle paths, further comprises instructions configured for:
utilizing a background subtraction to differentiate stationary from moving portions of said input video sequence;
utilizing a blob analysis to remove noise and identify a moving vehicle;
tracking a blob centroid to identify a vehicle path;
defining a length-based distance metric between two paths; and
clustering vehicle paths utilizing said distance metric.

15. The system of claim 14 said background subtraction employs a Gaussian mixture model.

16. The system of claim 14 wherein said instructions are further configured for computing said length-based distance metric between said two paths by:
generating a sampling of points along each path among said two paths;
identifying a corresponding point on a second path among said two paths as being a closest of all points on said second path for each point on a first path among said two paths; and
defining a distance between paths as an average of distances between all pairs of corresponding points.

17. The system of claim 14 wherein said instructions for clustering vehicle paths utilizing said distance metric, further comprises:
establishing a threshold on an inter-cluster distance; and
assigning two paths to a same cluster if a distance of said two paths is less than said threshold; and
assigning said two paths to different clusters if a distance of said two paths is greater than said threshold.

18. The system of claim 12 wherein said instructions for deriving said set of clusters of nominal trajectories within said nominal vehicle paths, further comprises instructions for:
assigning a monotonically increasing sequence of indices to sample points along a vehicle path;
defining a trajectory as an order by which said sequence of indices is visited by a vehicle along the said vehicle path;
defining a distance metric between two trajectories; and
clustering trajectories according to said distance metric.

19. The system of claim 12 wherein said instructions are further configured for determining said three successive stages by:
computing a path for a vehicle;
determining if said path belongs to at least one of a precomputed path class, and if so labeling said path as a nominal path, and if not, labeling said path as an anomalous path;
computing a trajectory for each nominal path;
determining if said trajectory belongs to at least one of a precomputed trajectory class, and if so labeling said trajectory as a nominal trajectory, and if not labeling said trajectory as an anomalous trajectory;
computing selected features along said nominal trajectory and a statistical distance between computed features and pre-computed feature distributions for each nominal trajectory; and
labeling a feature as nominal feature if a distance is less than a predetermined threshold, and if not labeling, said feature as an anomalous feature.

20. A processor-readable medium storing code representing instructions to cause a process to perform a multi-stage method for detecting anomalies in video footage of vehicle traffic, said code comprising code to:
derive in an offline process a set of clusters of nominal vehicle paths and a set of clusters of nominal trajectories within said nominal vehicle paths;
select in an offline process a set of features within each nominal trajectory among said set of clusters of nominal trajectories and deriving a probability distribution for features indicative of nominal vehicle behavior within said nominal trajectories; and
detect in three successive stages, anomalies in an input video sequence, said anomalies corresponding respectively to a path, a trajectory, and feature distributions.
